(19) United States
(12) Patent Application Publication
(10) Pub. No.: US 2005/0074150 A1
(43) Pub. Date: Apr. 7, 2005

(54) Systems and methods for emulating an angiogram using three-dimensional image data

(76) Inventor: Andrew Bruss, Plymouth, MN (US)

Correspondence Address: Schwegman, Lundberg, Woessner & Kluth, P.A., P.O. Box 2938, Minneapolis, MN, 55402, US

(21) Appl. No.: 10/679,250

(22) Filed: Oct. 3, 2003

(51) Int. Cl. G06K 9/00

(52) U.S. Cl. 382/128; 382/154

(57) ABSTRACT

Systems and methods provide an emulated angiogram from three-dimensional image data. The systems and methods load three-dimensional image data representing at least a portion of a body. The data is then segmented to create segmented blood vessel data and non-segmented data. The systems and methods maintain a first set of values for a rendering characteristic and a second set of values for the rendering characteristic. An emulated angiogram may be displayed by rendering the non-segmented data using the first set of values for the rendering characteristic and rendering the segmented blood vessel data using the second set of values for the rendering characteristic.

### FIELD

The present invention relates generally to computerized imaging systems, and more particularly to emulating an angiogram using three-dimensional image data.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2003, Vital Images, Inc. All Rights Reserved.

### BACKGROUND

Angiograms have proven to be a very useful tool for detecting disease of the arteries resulting from atherosclerosis and other conditions. Angiograms may be used for evaluating the coronary arteries (supplying the heart), renal arteries (supplying the kidneys), and carotid arteries (supplying the head).

An angiogram is typically performed by inserting a catheter (a long plastic tube) directly into the artery, and then injecting dye (typically iodine containing liquid that is opaque to x-rays), which makes the blood in the artery show up when an x-ray is taken. If there is no disease causing obstruction, the pictures look like a road map of the arteries. If there is plaque blocking the artery, the narrowing is clearly visible. An exemplary angiogram is illustrated in FIG. 1A.

While angiograms are useful in detecting diseases of the arteries, there are several problems and risks associated with angiograms due to the invasive nature of the procedure. For example, patients typically require that the catheter be put in under local anesthetic (usually through the femoral artery in the groin), and the dye that is injected can occasionally harm the kidneys if given in large amounts. The patient may require some sedation prior to the procedure. Further, the patient may experience a hot feeling when the dye is injected.

Additionally, there may be other complications related to an angiogram. For example, the patient may be allergic to the dye injected into the arteries. In the case of coronary angiograms, during the actual catheterization there may be temporary heart irritation from the catheter in the aorta or in the heart, causing minor heart beat irregularity or slowing of the heart rate. Also, the procedure may create a tiny air bubble or tiny clot that can travel to other organs or to the leg.

In view of the above, there is a need in the art for the present invention.

### SUMMARY

The above-mentioned shortcomings, disadvantages and problems are addressed by the present invention, which will be understood by reading and studying the following specification.

One aspect of the various embodiments includes systems and methods for emulating an angiogram from three-dimensional image data. The systems and methods load three-dimensional image data representing at least a portion of a body. The data is then segmented to create segmented blood vessel data and non-segmented data. The systems and methods maintain a first set of values for a rendering characteristic and a second set of values for the rendering characteristic. An emulated angiogram may be displayed by rendering the non-segmented data using the first set of values for the rendering characteristic and rendering the segmented blood vessel data using the second set of values for the rendering characteristic.

A further aspect of various embodiments is that the functions provided within the methods may be distributed between an image processing system and a graphics subsystem coupled to the image processing system.

The present invention describes systems, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1A is an exemplary angiogram produced by prior art systems;

FIGS. 1B-1C are exemplary emulated angiograms produced by embodiments of the invention;

FIG. 2 is a block diagram of an operating environment in which different embodiments of the invention can be practiced;

FIG. 3 is a flowchart illustrating a method for emulating an angiogram according to an embodiment of the invention; and

FIG. 4 is a diagram illustrating the major hardware components of a computer incorporating embodiments of the invention.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

The following detailed description is, therefore, not to be taken in a limiting sense, and the scope of the present invention is defined only by the appended claims.

### Operating Environment

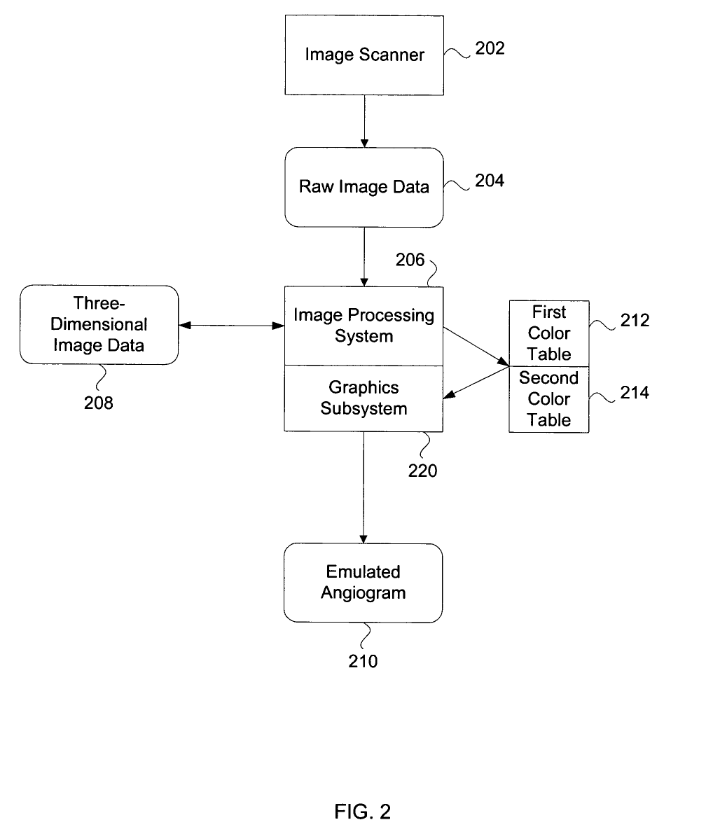

The embodiments of the invention describe a software environment of systems and methods that provide an emulated angiogram from three-dimensional medical images. FIG. 2 is a block diagram describing the major components of such a system. As shown, the system includes an image scanner 202 and an image processing system 204.

Image scanner 202 in one embodiment of the invention is a CT scanner. The scanner can be a high-speed helical CT scanner, or it can be an electron beam CT scanner. However, the invention is not limited to CT scanners, and any scanner that can provide a sequence of images taken over at least a portion of a body are within the scope of the invention. For example, scanner 202 could be a Magnetic Resonance Imaging (MRI) or ultrasound scanner. Additionally, the images may be taken over a period of time, and changes over the time period may be analyzed.

Scanner 202 produces image data 204 that comprises a sequence of two-dimensional images of the human body. This image data is then sent to image processing system 206 for processing. In one embodiment of the invention, image processing system 206 is the Vitrea system from Vital Images, Inc. The image data can be transferred from scanner 202 to image processing system 204 using any data transmission means, including tape media, CD-ROM, floppy-disk, removable hard drive, and network means, including the Internet.

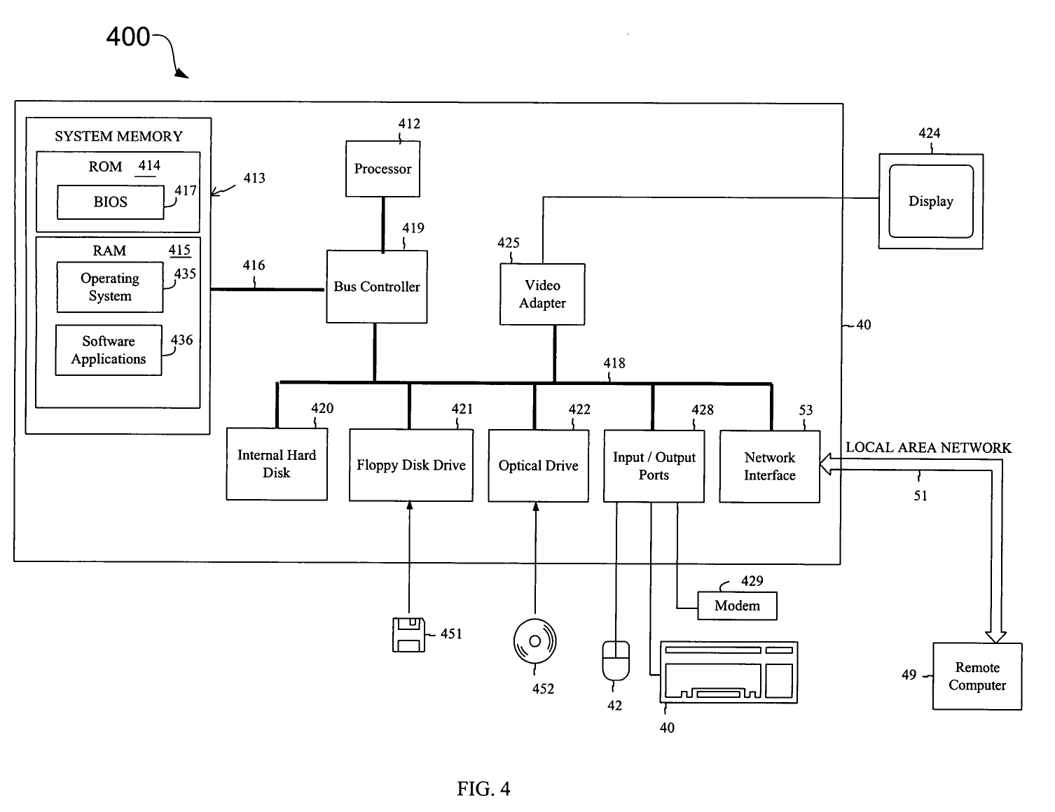

Image processing system 206 is a suitably configured computer, such as the computer illustrated below in FIG. 4, and creates three-dimensional image data 208 that may be rendered on a display of computer system 206. In some embodiments, image processing system 206 employs the methods detailed below to provide an emulated angiogram 210.

Image processing system 206 may include a graphics subsystem 220 that provides. graphics and video functions for image processing system 206. In some embodiments, graphics subsystem 220 may be integrated on a single chip or chip set that is integrated on a motherboard including general purpose processors and memory. In alternative embodiments, graphics subsystem 220 may reside on a video controller card, for example video adapter 425 (FIG. 4), removably coupled to image processing system 206 via a bus connection. Graphics subsystem 220 may include various graphics processors such as a 3-dimensional (3D) engine, 2-dimensional (2D) engine, video engine, etc.

This section has described the various system components in a system that performs emulated angiograms based on three-dimensional image data. As those of skill in the art will appreciate, the software can be written in any of a number of programming languages known in the art, including but not limited to C/C++, Visual Basic, Smalltalk, Pascal, Ada and similar programming languages. The invention is not limited to any particular programming language for implementation.

### Methods

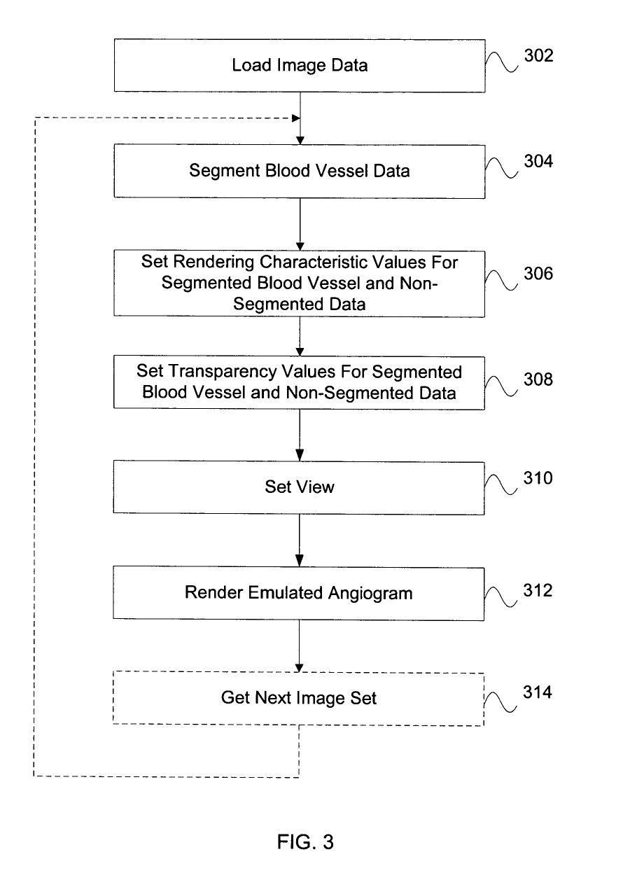

FIG. 3 is a flowchart illustrating methods for providing an emulated angiogram using three-dimensional image data according to an embodiment of the invention. The methods to be performed by the operating environment constitute computer programs and/or modules made up of computer-executable instructions. Describing the methods by reference to a flowchart enables one skilled in the art to develop such programs including such instructions to carry out the methods on suitable computers (the processor or processors of the computer executing the instructions from computer-readable media). The methods illustrated in FIG. 3 are inclusive of acts that may be taken by an operating environment executing an exemplary embodiment of the invention.

A system executing the method begins by loading three-dimensional image data (block 302). Typically the three-dimensional image data will represent a portion of a body, such as a human or animal body. In some embodiments, the three-dimensional data is voxel data. In alternative embodiments, the three-dimensional data may be a set of three-dimensional polygonal surfaces such as isosurfaces. The present invention is not limited to any particular representation for the three-dimensional data.

In some embodiments, the three-dimensional image data is created from a series of two-dimensional image slices provided by a CT scanner. In alternative embodiments, the three-dimensional image data may be created from MR data. The invention is not limited to any particular source for creating the three-dimensional image data.

In some embodiments, the three-dimensional image data may be divided into foreground and background data. For example, in a three-dimensional image for a chest region, the background data may comprise the ribs and the chest cavity, and the foreground data may comprise the heart and surrounding blood vessels. Another example is a three-dimensional image of a human head, in an exam called Circle of Willis, in which the background includes the skull bone and the foreground comprises the blood vessels within the brain. In other embodiments, the distinction between foreground and background is not needed. For example to examine renal arties no distinction between a foreground or background is necessary.

Next, data representing one or more blood vessels are segmented from the three-dimensional image data (block 304). In some embodiments, the selection of blood vessels to be segmented within the three-dimensional image data is a partially manual process using a user-interface such as a pointer controlled by a mouse or trackball that may be used to select the one or more blood vessels of interest. However, automated means of selection could also be used and are within the scope of the invention.

Once selected, the data associated with the selected blood vessels is segmented from the three-dimensional data using the selection point as a seed value. Various mechanisms may be used to segment the blood vessel data. In some embodiments level set segmentation techniques as known in the art may be used. In alternative embodiments segmentation based on active shape models may be used. In further alternative embodiments region growing segmentation techniques are used. The present invention is not limited to any particular segmentation technique.

A system executing the method sets a first set of values for a rendering characteristic and a second set of values for the rendering characteristic (block 306). In some embodiments, the rendering characteristic comprises color values. However, other rendering characteristics such as transparency may also be used.

In embodiments where the rendering characteristic is color, a first color table 212 (FIG. 2) is used to represent the non-segmented three-dimensional data (e.g. background data and foreground data that is not the segmented blood vessel), and a second color table 214 (FIG. 2) is used to represent the segmented blood vessel data. In some embodiments, the first and second color tables may be monochrome color tables. The monochrome color table for the non-segmented data may be defined such that foreground data is rendered in shades of white on background data that is rendered in shades of black. Alternatively, the monochrome color table may be defined such that foreground data is rendered in shades of black on background data that is rendered in shades of white. In some embodiments, the monochrome color table for the segmented blood vessel data is an inverse of the color table for the non-segmented data. In one embodiment, the color table is inverted by subtracting the color value from a white color value.

In alternative embodiments, the second color table for the segmented blood vessel data may comprise a plurality of colors while the first color table for the non-segmented data may comprise a monochrome color table. In further alternative embodiments, both color tables may comprise plurality of colors, with colors in one color table differing from the colors in the other. For example, a set of “cool” tones (e.g. blues and greens) may be used for the non-segmented data while “warm” tones (e.g. yellows and reds) may be used for the segmented blood vessel data.

It should be noted that first and second color tables 212 and 214 may exist in various forms. For example, In some embodiments, first and second color tables are separate color tables in separate memory sections. In alternative embodiments, first and second color tables are separate sections of a single color table maintained by a graphics subsystem. In further alternative embodiments, first and second color tables comprise values loaded into a single color table at separate points in the execution of the method. For example, first color table 212 may be loaded while rendering non-segmented vessel data and second color table 214 may be loaded while rendering segmented blood-vessel data.

In some embodiments, if the rendering characteristic is color, then transparency may be used in addition to color to emulate an angiogram (block 308). In some embodiments, non-blood vessel data is rendered at approximately 80 percent transparency, while segmented blood vessel data is rendered at 30 percent transparency. In alternative embodiments, the non-blood vessel data may be rendered at 90 percent transparency. While the actual transparency value used may vary from those listed, it is desirable that the transparency value for non-blood vessel data be approximately 50 percentage points or more greater than that for the segmented blood vessel data. It should be noted that opacity values could also be used, such values being the inverse of transparency values.

In some embodiments a view may be selected (block 310). In some embodiments, the three-dimensional data may be rotated to any desired view. In alternative embodiments, a predetermined set of views may be chosen. A coronary exam, for example, may include these views: Right Anterior Oblique (RAO), Left Anterior Oblique (LAO), and Left Anterior Oblique with Cranial Angulation (LAO-CRA). In either case, the view may be a perspective view that provides depth cuing, or the view may be an orthographic view.

Next, the data is rendered in accordance with the setting described above to produce an emulated angiogram (block 312).

In some embodiments, the rendered angiogram is a static view. However, in alternative embodiments, the rendering may be animated using data taken at differing points in time to show blood flow through the segmented blood vessel at the differing points in time. In these embodiments, the system generates the animated view by retrieving the next image data from a series of images taken over time (block 314) and repeating the execution of blocks 304-312 on the next image data in the series. The series of image data may be taken during a single image acquisition session (e.g. by a helical CT scanning system) or the series of image data may be taken over multiple image scanning session. No embodiment of the invention is limited to any particular method of gathering the series of image data.

The functionality in the methods described above may be distributed across various hardware components of an image processing system 206. For example, in some embodiments, the selection of blood vessels, segmentation, and color table setting may be performed by the image processing system while display functions related to rendering such as color table lookup and application of transparency values may be performed by graphics subsystem 220. However, in alternative embodiments, functions such as segmentation and color table setting may be performed by graphics subsystem 220 while image processing system 206 provides selection mechanisms used to select blood vessel data to be segmented.

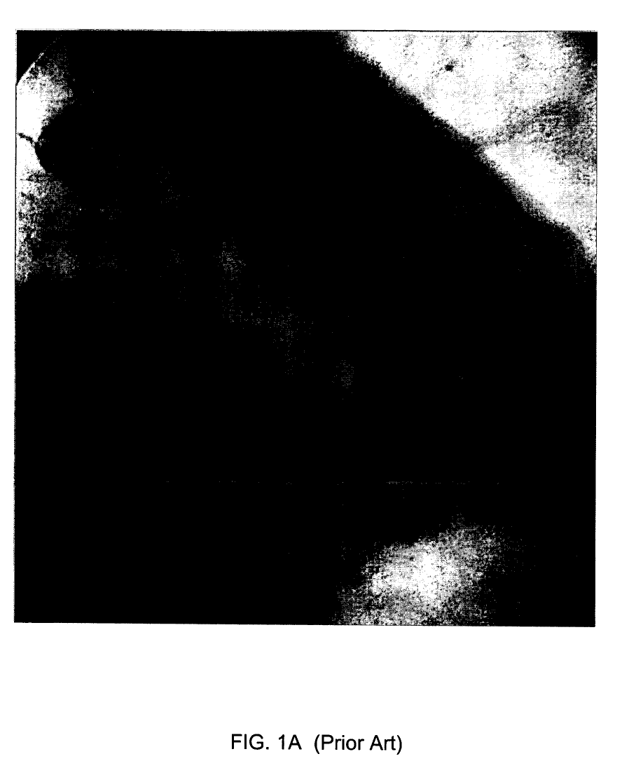

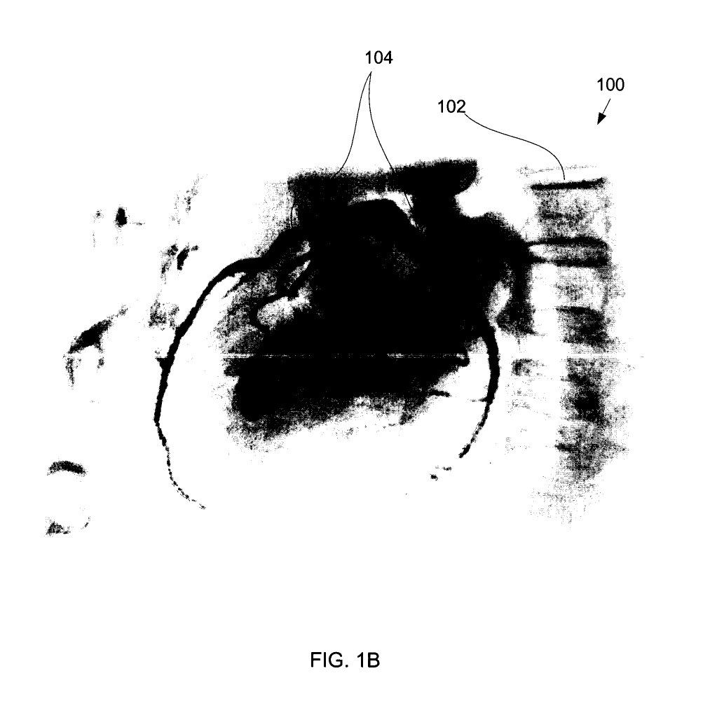

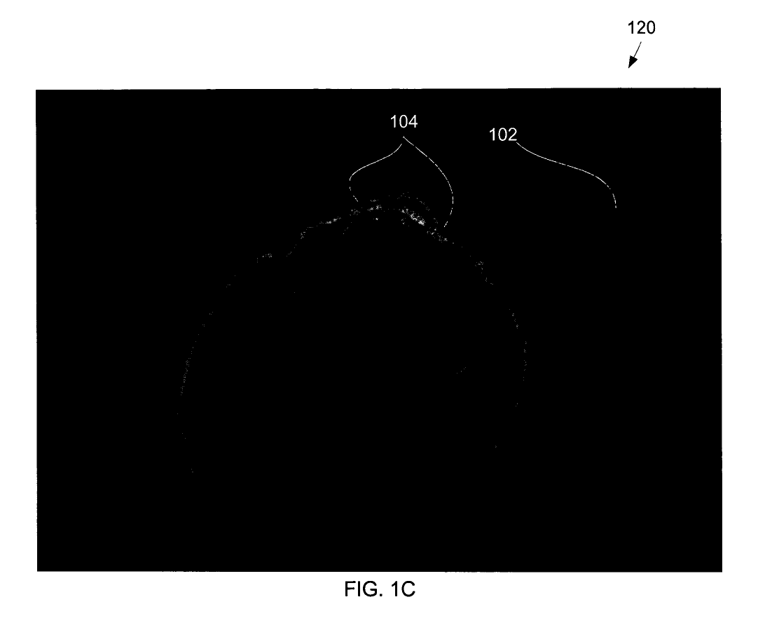

FIGS. 1B and 1C are illustrations of exemplary emulated angiograms according to embodiments of the invention. FIG. 1B is an illustration of an exemplary emulated angiogram 100 using two monochrome color tables with a black image on a white background. Non-segmented image data 102 is shown rendered at a relatively high transparency value while segmented blood vessel data 104 is shown rendered at a lower transparency value and using an inverted color table.

FIG. 1C is an illustration of an exemplary emulated angiogram 120 using two monochrome color tables with a white image on a black background. Again, non-segmented image data 102 is shown rendered at a relatively high transparency value while segmented blood vessel data 104 is shown rendered at a lower transparency value and using an inverted color table.

### Hardware Environment

FIG. 4 is a diagram of the hardware and operating environment in conjunction with which embodiments of the invention may be practiced. The description of FIG. 4 is intended to provide a brief, general description of suitable computer hardware and a suitable computing environment in conjunction with which the invention may be implemented. Although not required, the invention is described in the general context of computer-executable instructions, such as program modules, being executed by a computer, such as a personal computer or a server computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

As shown in FIG. 4, the computing system 400 includes a processor. The invention can be implemented on computers based upon microprocessors such as the PENTIUM® family of microprocessors manufactured by the Intel Corporation, the MIPS® family of microprocessors from the Silicon Graphics Corporation, the POWERPC® family of microprocessors from both the Motorola Corporation and the IBM Corporation, the PRECISION ARCHITECTURE® family of microprocessors from the Hewlett-Packard Company, the SPARC® family of microprocessors from the Sun Microsystems Corporation, or the ALPHA® family of microprocessors from the Compaq Computer Corporation. Computing system 400 represents any personal computer, laptop, server, or even a battery-powered, pocket-sized, mobile computer known as a hand-held PC.

The computing system 400 includes system memory 413 (including read-only memory (ROM) 414 and random access memory (RAM) 415), which is connected to the processor 412 by a system data/address bus 416. ROM 414 represents any device that is primarily read-only including electrically erasable programmable read-only memory (EEPROM), flash memory, etc. RAM 415 represents any random access memory such as Synchronous Dynamic Random Access Memory.

Within the computing system 400, input/output bus 418 is connected to the data/address bus 416 via bus controller 419. In one embodiment, input/output bus 418 is implemented as a standard Peripheral Component Interconnect (PCI) bus. The bus controller 419 examines all signals from the processor 412 to route the signals to the appropriate bus. Signals between the processor 412 and the system memory 413 are merely passed through the bus controller 419. However, signals from the processor 412 intended for devices other than system memory 413 are routed onto the input/output bus 418.

Various devices are connected to the input/output bus 418 including hard disk drive 420, floppy drive 421 that is used to read floppy disk 451, and optical drive 422, such as a CD-ROM drive that is used to read an optical disk 452. The video display 424 or other kind of display device is connected to the input/output bus 418 via a video adapter 425.

A user enters commands and information into the computing system 400 by using a keyboard 40 and/or pointing device, such as a mouse 42, which are connected to bus 418 via input/output ports 428. Other types of pointing devices (not shown in FIG. 4) include track pads, track balls, joy sticks, data gloves, head trackers, and other devices suitable for positioning a cursor on the video display 424.

As shown in FIG. 4, the computing system 400 also includes a modem 429. Although illustrated in FIG. 4 as external to the computing system 400, those of ordinary skill in the art will quickly recognize that the modem 429 may also be internal to the computing system 400. The modem 429 is typically used to communicate over wide area networks (not shown), such as the global Internet. The computing system may also contain a network interface card 53, as is known in the art, for communication over a network.

Software applications 436 and data are typically stored via one of the memory storage devices, which may include the hard disk 420, floppy disk 451, CD-ROM 452 and are copied to RAM 415 for execution. In one embodiment, however, software applications 436 are stored in ROM 414 and are copied to RAM 415 for execution or are executed directly from ROM 414.

In general, the operating system 435 executes software applications 436 and carries out instructions issued by the user. For example, when the user wants to load a software application 436, the operating system 435 interprets the instruction and causes the processor 412 to load software application 436 into RAM 415 from either the hard disk 420 or the optical disk 452. Once software application 436 is loaded into the RAM 415, it can be used by the processor 412. In case of large software applications 436, processor 412 loads various portions of program modules into RAM 415 as needed.

The Basic Input/Output System (BIOS) 417 for the computing system 400 is stored in ROM 414 and is loaded into RAM 415 upon booting. Those skilled in the art will recognize that the BIOS 417 is a set of basic executable routines that have conventionally helped to transfer information between the computing resources within the computing system 400. These low-level service routines are used by operating system 435 or other software applications 436.

In one embodiment computing system 400 includes a registry (not shown) which is a system database that holds configuration information for computing system 400. For example, Windows® 95, Windows 98®, Windows® NT, Windows 2000® and Windows XP® by Microsoft maintain the registry in two hidden files, called USER.DAT and SYSTEM.DAT, located on a permanent storage device such as an internal disk.

### Conclusion

Systems and methods for emulating an angiogram using three-dimensional image data have been disclosed. The systems and methods described provide advantages over previous systems. For example, the systems and methods for providing an emulated angiogram of the present invention are far less invasive than prior systems of generating an angiogram.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

1. A method for emulating an angiogram from three-dimensional image data, the method comprising:
loading three-dimensional image data representing at least a portion of a body;
segmenting at least a portion of the blood vessel data from the three-dimensional data to create segmented blood vessel data and non-segmented data;
maintaining a first set of values for a rendering characteristic and a second set of values for the rendering characteristic; and
rendering the non-segmented data using the first set of values for the rendering characteristic and rendering the segmented blood vessel data using the second set of values for the rendering characteristic.

2. The method of claim 1, wherein the rendering characteristic is color, wherein the first set of values comprises a first color table and the second set of values comprises a second color table.

3. The method of claim 2, wherein the first color table and is a monochrome color table such that the non-segmented data is rendered as shades of white on a black background.

4. The method of claim 2, wherein the first color table and is a monochrome color table such that the non-segmented data is rendered as shades of black on a white background.

5. The method of claim 2, wherein the first color table is a monochrome color table and the second color table includes a plurality of colors.

6. The method of claim 2, wherein the first color table includes a plurality of first colors and the second color table includes a plurality of second colors wherein the first colors are different from the second colors.

7. The method of claim 1, further comprising inverting the first set of values to form the second set of values.

8. The method of claim 2, further comprising rendering the non-segmented data using a first transparency value and rendering the segmented blood vessel data using a second transparency value.

9. The method of claim 8, wherein the first transparency value is more than approximately fifty percent greater than the second transparency value.

10. The method of claim 8, wherein the first transparency value is approximately 80 percent and the second transparency value is approximately 30 percent.

11. The method of claim 8, wherein the second color table includes a plurality of colors, the first transparency value is approximately 90 percent, and the second transparency value is approximately 30 percent.

12. The method of claim 1, further comprising setting a view.

13. The method of claim 12, wherein the view is a perspective view.

14. The method of claim 12, wherein the view is an orthographic view.

15. The method of claim 14, wherein the view is selected from the group consisting of: Right Anterior Oblique (RAO), Left Anterior Oblique (LAO), and Left Anterior Oblique with Cranial Angulation (LAO-CRA).

16. The method of claim 1, wherein the three-dimensional image data comprises a series of three-dimensional image data sets and further comprising providing an animated view of the segmented blood vessel data and non-segmented blood vessel data.

17. The method of claim 16, wherein providing an animated view of the segmented blood vessel data and non-segmented blood vessel data comprises repeating the segmenting task and rendering task for each image data set in at least a subset of the series of three-dimensional image data sets:

18. An image processing system comprising:
a processor;
a memory coupled to the processor; and
a graphics subsystem coupled to the processor;
wherein the processor is operable to:
load three-dimensional image data representing at least a portion of a body;
segment at least a portion of the blood vessel data from the three-dimensional data to create segmented blood vessel data and non-segmented data;
maintain a first set of values for a rendering characteristic and a second set of values for the rendering characteristic; and
cause the graphics subsystem to render the non-segmented data using the first set of values for the rendering characteristic and render the segmented blood vessel data using the second set of values for the rendering characteristic.

19. The image processing system of claim 18, wherein the rendering characteristic is color, wherein the first set of values comprises a first color table and the second set of values comprises a second color table.

20. The image processing system of claim 19, wherein the first color table and is a monochrome color table such that the non-segmented data is rendered as shades of white on a black background.

21. The image processing system of claim 19, wherein the first color table and is a monochrome color table such that the non-segmented data is rendered as shades of black on a white background.

22. The image processing system of claim 19, wherein the first color table is a monochrome color table and the second color table includes a plurality of colors.

23. The image processing system of claim 19, wherein the first color table includes a plurality of first colors and the second color table includes a plurality of second colors wherein the first colors are different from the second colors.

24. The image processing system of claim 18, further comprising inverting the first set of values to form the second set of values.

25. The image processing system of claim 19, further wherein the processor is further operable to render the non-segmented data using a first transparency value and render the segmented blood vessel data using a second transparency value.

26. The image processing system of claim 25, wherein the first transparency value is more than approximately fifty percent greater than the second transparency value.

27. The image processing system of claim 25, wherein the first transparency value is approximately 80 percent and the second transparency value is approximately 30 percent.

28. The image processing system of claim 25, wherein the second color table includes a plurality of colors, the first transparency value is approximately 90 percent, and the second transparency value is approximately 30 percent.

29. A graphics subsystem comprising:
a graphics processor; and
a memory coupled to the graphics processor;
wherein the graphics processor is operable to:
receive a selection of blood vessel data from three-dimensional data
segment the selected blood vessel data to create segmented blood vessel data and non-segmented data;
receive a first set of values for a rendering characteristic and a second set of values for the rendering characteristic; and
render the non-segmented data using the first set of values for the rendering characteristic and render the segmented blood vessel data using the second set of values for the rendering characteristic.

30. The graphics subsystem of claim 29, wherein the rendering characteristic is color, wherein the first set of values comprises a first color table and the second set of values comprises a second color table.

31. The graphics subsystem of claim 30, wherein the first color table and is a monochrome color table such that the non-segmented data is rendered as shades of white on a black background.

32. The graphics subsystem of claim 30, wherein the first color table and is a monochrome color table such that the non-segmented data is rendered as shades of black on a white background.

33. The graphics subsystem of claim 30, wherein the first color table is a monochrome color table and the second color table includes a plurality of colors.

34. The graphics subsystem of claim 30, wherein the first color table includes a plurality of first colors and the second color table includes a plurality of second colors wherein the first colors are different from the second colors.

35. The graphics subsystem of claim 29, further comprising inverting the first set of values to form the second set of values.

36. The graphics subsystem of claim 30, wherein the processor is operable to render the non-segmented data using a first transparency value and render the segmented blood vessel data using a second transparency value.

37. The graphics subsystem of claim 36, wherein the first transparency value is more than approximately fifty percent greater than the second transparency value.

38. The graphics subsystem of claim 36, wherein the first transparency value is approximately 80 percent and the second transparency value is approximately 30 percent.

39. The graphics subsystem of claim 36, wherein the second color table includes a plurality of colors, the first transparency value is approximately 90 percent, and the second transparency value is approximately 30 percent.

40. A computer-readable medium having computer-executable instructions for performing a method for emulating an angiogram from three-dimensional image data, the method comprising:
loading three-dimensional image data representing at least a portion of a body;
segmenting at least a portion of the blood vessel data from the three-dimensional data to create segmented blood vessel data and non-segmented data;
maintaining a first set of values for a rendering characteristic and a second set of values for the rendering characteristic; and
rendering the non-segmented data using the first set of values for the rendering characteristic and rendering the segmented blood vessel data using the second set of values for the rendering characteristic.

41. The computer-readable medium of claim 40, wherein the rendering characteristic is color, wherein the first set of values comprises a first color table and the second set of values comprises a second color table.

42. The computer-readable medium of claim 41, wherein the first color table and is a monochrome color table such that the non-segmented data is rendered as shades of white on a black background.

43. The computer-readable medium of claim 41, wherein the first color table and is a monochrome color table such that the non-segmented data is rendered as shades of black on a white background.

44. The computer-readable medium of claim 41, wherein the first color table is a monochrome color table and the second color table includes a plurality of colors.

45. The computer-readable medium of claim 41, wherein the first color table includes a plurality of first colors and the second color table includes a plurality of second colors wherein the first colors are different from the second colors.

46. The computer-readable medium of claim 40, wherein the method further comprises inverting the first set of values to form the second set of values.

47. The computer-readable medium of claim 41, further comprising rendering the non-segmented data using a first transparency value and rendering the segmented blood vessel data using a second transparency value.

48. The computer-readable medium of claim 47, wherein the first transparency value is more than approximately fifty percent greater than the second transparency value.

49. The computer-readable medium of claim 47, wherein the first transparency value is approximately 80 percent and the second transparency value is approximately 30 percent.

50. The computer-readable medium of claim 47, wherein the second color table includes a plurality of colors, the first transparency value is approximately 90 percent, and the second transparency value is approximately 30 percent.

51. The computer-readable medium of claim 40, further comprising setting a view.

52. The computer-readable medium of claim 51, wherein the view is a perspective view.

53. The computer-readable medium of claim 51, wherein the view is an orthographic view.

54. The computer-readable medium of claim 53, wherein the view is selected from the group consisting of: Right Anterior Oblique (RAO), Left Anterior Oblique (LAO), and Left Anterior Oblique with Cranial Angulation (LAO-CRA).

55. The computer-readable medium of claim 40, wherein the three-dimensional image data comprises a series of three-dimensional image data sets and further comprising providing an animated view of the segmented blood vessel data and non-segmented blood vessel data.

56. The computer-readable medium of claim 55, wherein providing an animated view of the segmented blood vessel data and non-segmented blood vessel data comprises repeating the segmenting task and rendering task for each image data set in at least a subset of the series of three-dimensional image data sets:
